(19) United States
(12) Patent Application Publication
(10) Pub. No.: US 2008/0203890 A1
(43) Pub. Date: Aug. 28, 2008

(54) Low-Pressure Gas Discharge Lamp Having a Gallium-Containing Gas Filling

(76) Inventors: Rainer Hilbig, Aachen (DE); Robert Scholl, Roetgen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/573,557

(22) PCT Filed: Sep. 20, 2004
(86) PCT No.: PCT/IB2004/051798

§ 371 Date: Feb. 27, 2008

(30) Foreign Application Priority Data
Sep. 30, 2003 (EP) 03103615.5

(51) Int. Cl. H01J 61/02

(52) U.S. Cl. 313/484; 313/638; 313/572

(57) ABSTRACT

A low-pressure gas discharge lamp is described that has, in a gas-discharge vessel, one or more inert gases as a buffer gas and means for producing, and maintaining a low-pressure gas discharge and that contains a gallium halide or a mixture of a plurality of gallium halides, to which indium and/or thallium may also preferably be added. A low-pressure gas discharge lamp of this kind produces sufficient UV radiation for it to be used in tanning devices.

The invention relates to a low-pressure gas discharge lamp that contains, in a gas-discharge vessel, one or more inert gases as a buffer gas and means for producing and maintaining a low-pressure gas discharge.

The generation of light in most prior as low-pressure gas discharge lamps is based on the fact of charge carriers, particularly electrons but also ions, being so much accelerated by an electrical field between the electrodes of the lamp that, in the gas filling of the lamp, they excite or ionize the atoms or molecules of the filling by colliding with them. When the atoms or molecules of the gas filling revert to their ground state, a greater or lesser proportion of the energy of excitation is converted into radiation.

Conventional low-pressure gas discharge lamps contain mercury in the gas filling and also have a phosphor coating on the inside of the gas discharge vessel. It is a disadvantage of mercury low-pressure gas discharge lamps that mercury emits radiation primarily in the high-energy but non-visible UV-C range of the electromagnetic spectrum and this radiation has first to be converted by phosphors into visible radiation of substantially lower energy. In the process, the difference in energy is converted into unwanted heat.

However, due to its toxic effect, the mercury in the gas filling is widely objected to nowadays and wherever possible is no longer used in modem-day mass-produced items.

It is already known for the spectrum of low-pressure gas discharge lamps to be acted on by replacing the mercury in the gas filling with other substances. In this way, there are described in German patent applications laid open to public inspection DE 100 44 562, DE 100 44 563, DE 101 28 915 and DE 101 29 464 low-pressure gas discharge lamps that contain a gas filling comprising a compound of copper, a compound of indium or a compound of thallium together with an inert gas as a buffer gas. These lamps are notable for the higher radiation yield that they have in the visible range of the electromagnetic spectrum than conventional mercury low-pressure gas discharge lamps. Also, their visual efficiency can be even further improved by incorporating additives and phosphors and by controlling the internal pressure in the lamp and the operating temperature.

Halides of gallium have not so far been used as radiating substances in low-pressure gas discharge lamps

It has now been found that the use of halides of gallium as radiating substances has various advantages over conventional mercury low-pressure gas discharge lamps, even apart from the fact that the filling is environmentally friendly.

A first object of the invention is therefore a low-pressure gas discharge lamp that, in a gas discharge vessel, has one or more inert gases as a buffer gas plus electrodes and means for producing and maintaining a low-pressure gas discharge and contains a gallium halide or a mixture of a plurality of gallium halides.

However, the radiation efficiency of a low-pressure gas discharge lamp of this kind is still not entirely satisfactory. Its radiation efficiency both in the visible and the ultraviolet ranges is less than 5%. It was therefore a further object to increase the radiation yield of a low-pressure gas discharge lamp of this kind. This object is achieved in accordance with the invention when a low-pressure gas discharge lamp of this kind also contains, in addition to one or more gallium halides, indium and/or thallium.

It has been found in this case that the radiation yield can be increased in a particularly advantageous manner if the low-pressure gas discharge lamp contains the elements gallium, halogen and indium and/or thallium in the following molar proportions: the expression governing the molar proportions of Z is: m(Z)>0, and the expression governing the molar proportions of X, Ga and Z is: m(X)<m(Ga)+m(Z). In these expressions, X stands for fluorine, chlorine, bromine and/or iodine and Z for indium and/or thallium.

By virtue of the above combination of the elements gallium, halogen and indium/thallium, it is possible for a low-pressure gas discharge lamp to be produced that emits an adequate level of UV radiation for it to be used directly in tanning devices.

However, what is also possible is for a phosphor to be introduced into the low-pressure gas discharge lamp, by which phosphor the proportion of UV light in the radiation generated is converted into visible light, thus giving a high efficiency.

The discharge conditions are advantageously set in such a way that the total concentration of the gallium and/or indium/thallium halides in the gas phase in the gas-discharge vessel is 2×10⁻⁹ to 2×10⁻¹¹ mol/cm³. The preferred concentration in the gas phase is 2×10⁻¹⁰ mol/cm³. This corresponds to an operating pressure of approximately 10 μbar. When Z=indium is used, the pressure is obtained by setting the wall temperature of the discharge vessel to a temperature of T*±50K. Here, T* is approximately 200° C. for chlorine systems, approximately 220° C. for bromine systems and approximately 265° C. for iodine systems. When Z=thallium is used, T* is approximately 280° C. for all halide systems.

The losses that occur in the course of heating can be minimized by the use of a heat-reflecting outer envelope, in a similar way to what is done in the case of an SOX lamp.

It has proved beneficial for the vapor pressure of the inert gas in the gas-discharge vessel to be set to a range of less than 100 mbar and preferably to approximately 2 mbar.

The discharge vessel may be composed of glass materials such as quartz, aluminum oxide, granular yttrium-aluminum or similar wall materials that are known in the prior art. It may be of any desired geometry but the preferred configurations for the discharge vessel are cylindrical or spherical.

The discharge may be excited capacitively by two external electrodes or one external and one internal electrode and a high-frequency alternating field of e.g. 2.65 MHz, 13.65 MHz, . . . 2.4 GHz etc.

Electrical excitation with two inner electrodes made of high-melting metals such as tungsten and rhenium is also possible. The internal electrodes may also be provided with an emitter material having a low work function.

Especially preferred is an embodiment of the invention wherein the discharge is excited inductively. In this embodiment the discharge is not excited between two electrodes, but “electrodeless” in a discharge vessel shaped as a closed ring. The energy for exciting the discharge is injected via a magnetic field e.g. by two ferrite core coils.

According to a further embodiment of inductive operation the energy is injected via a high frequency antenna loaded by a separate 2.65 MHz generator into a pea-shaped discharge vessel.

Inductively operated low pressure discharge lamps do not contain any wear parts. Such lamps are especially useful as backlighting of LCD-Displays, in UV-disinfection and UV-curing of resins, as they show extreme longevity.

These and other aspects of the invention will be elucidated below with reference to two examples.

### EXAMPLE 1

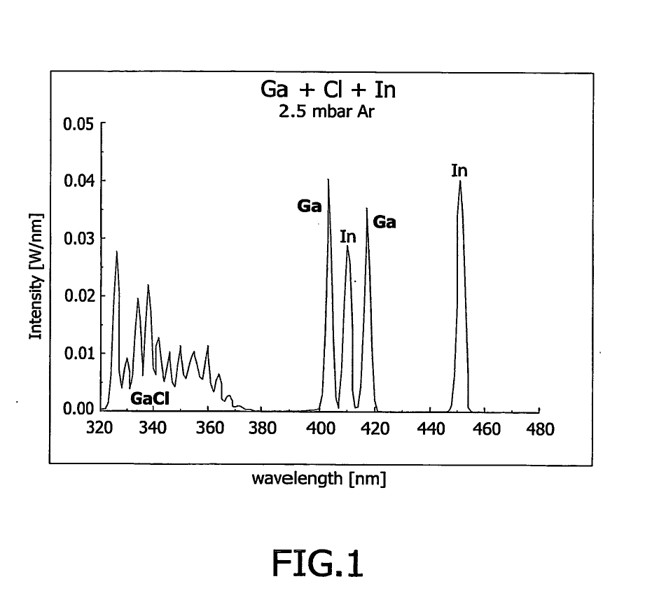

FIG. 1 shows the spectrum of a discharge excited at 13.65 MHz by external electrodes, in the range from 320 nm to 480 nm. It is in this spectral range that the main emission from the discharge takes place.

The discharge vessel was cylindrical and had a length of 25 cm and a diameter of 2.5 cm. The filling comprised 0.2 mg of gallium, 0.1 mg of chlorine and 0.3 mg of indium. The buffer gas used was 2.5 mbar of argon (cold pressure). The discharge power was 4 W. The wall temperature was set to 200° C.

Clearly apparent in FIG. 1 are the blue gallium lines at 403 and 417 nm (as well as the indium lines at 410 nm and 451 nm that are also visible). The molecular band spectrum over the range λ=330 nm to 370 nm is essentially the emission from the gallium monochloride. Under the conditions given, the plasma efficiency η of the discharge was η=30%

### EXAMPLE 2

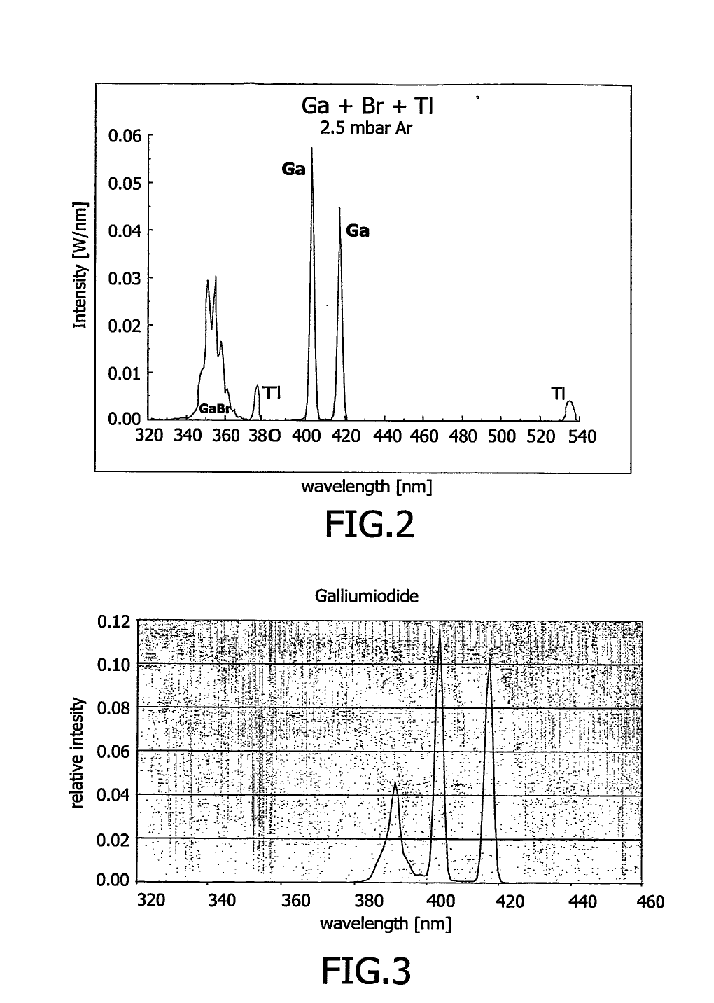

FIG. 2 shows the spectrum of a discharge excited at 13.65 MHz by external electrodes, in the range from 320 nm to 550 nm. It is in this spectral range that the main emission from the discharge takes place.

The discharge vessel was cylindrical and had a length of 25 cm and a diameter of 2.5 cm. The filling comprised 0.2 mg of gallium, 0.06 mg of bromine and 0.14 mg of thallium. The buffer gas used was 2.5 mbar of argon (cold pressure). The discharge power was 3 W. The wall temperature was set to 250° C.

Clearly apparent are the blue gallium lines at 403 and 417 nm (as well as the thallium lines at 378 nm and 535 nm that are also visible). The molecular band spectrum over the range λ=345 nm to 370 nm is essentially the emission from the gallium monobromide. Under the conditions given, the plasma efficiency η of the discharge was η=28%.

### EXAMPLE 3

FIG. 3 shows the spectrum of a discharge excited at 13.65 MHz by external electrodes, in the range of 320 to 460 nm.

The discharge vessel was cylindrically and had a length of 25 cm and a diameter of 2.5 cm. The filling comprised 0.5 mg gallium and 0.065 mg iodine. The buffer gas used was 2.5 mbar argon (cold pressure). The discharge power was 3 W. The wall temperature was set to 170° C. Clearly apparent in FIG. 3 are the blue gallium lines at 403 and 417 nm. The molecular band spectrum over the range λ=380 to 400 nm is essentially the emission from gallium monoiodide. Under the conditions given, the plasma efficiency η of the discharge was η=25%.

1. A low-pressure gas discharge lamp that has, in a gas-discharge vessel, one or more inert gases as a buffer gas and means for producing and maintaining a low-pressure gas discharge, characterized in that it contains a gallium halide or a mixture of a plurality of gallium halides.

2. A low-pressure gas discharge lamp as claimed in claim 1, characterized in that, in addition to one or more gallium halides, it also contains indium and/or thallium.

3. A low-pressure gas discharge lamp as claimed in claim 1, characterized in that it contains the elements gallium, halogen and indium and/or thallium in the following molar proportions: the expression governing the molar proportions of Z is: m(Z)>0, and the expression governing the molar proportions of X, Ga and Z is: m(X)<m(Ga)+m(Z), where X stands for fluorine, chlorine, bromine and/or iodine and Z for indium and/or thallium.

4. A low-pressure gas discharge lamp as claimed in claim 1, characterized in that the total concentration of the gallium and indium/thallium halides in the gas phase in the gas-discharge vessel is 2×10⁻⁹ to 2×10⁻¹¹ mol/cm³.

5. A low-pressure gas discharge lamp as claimed in claim 1, characterized in that the gas-discharge vessel is surrounded by a heat-reflecting outer envelope.

6. A low-pressure gas discharge lamp as claimed in claim 1, characterized in that the inert gas pressure in the gas-discharge vessel is between 1 and 5 mbar.

7. A low-pressure gas discharge lamp as claimed in claim 1, characterized in that the discharge is excited capacitively or inductively and by a high-frequency alternating field.

8. A low-pressure gas discharge lamp as claimed in claim 1, characterized in that the discharge can be excited by internal electrodes made of high-melting-point materials.

9. A low-pressure gas discharge lamp as claimed in claim 8, characterized in that the internal electrodes are provided with a material having a low work function.

10. A low-pressure gas discharge lamp as claimed in claim 1, characterized in that it contains a phosphor by which the proportion of UV in the radiation generated is converted into visible radiation.

11. An illumination device, characterized in that it includes one or more low-pressure gas discharge lamps as claimed in claim 1.

12. An illumination device, selected from the group of tanning devices, backlighting devices for LCD-displays, UV-disinfection devices and UV-curing devices for resins.
